(19) United States
(12) Patent Application Publication
(10) Pub. No.: US 2016/0037338 A1
(43) Pub. Date: Feb. 4, 2016

(54) PRIVATE WIRELESS COMMUNICATION NETWORK FOR GUEST USERS

(71) Applicant: SYMBOL TECHNOLOGIES, INC., Schaumburg, IL (US)

(72) Inventors: Sriram Venkiteswaran, San Jose, CA (US); Carroll A. Calamari, Princeton, MA (US)

(21) Appl. No.: 14/446,381

(22) Filed: Jul. 30, 2014

(51) Int. Cl. H04W 12/06; H04L 29/06

(52) U.S. Cl. CPC H04W 12/06; H04L 63/0853

(57) ABSTRACT

A system and technique to provide a private wireless communication network for guest users includes providing a guest user profile, including at least a defined service set identification and pre-shared key of a home wireless network of the guest user. A next step includes creating a private wireless communication network with a unique identifier. A next step includes broadcasting the defined service set identification of the guest user home wireless network that is in the guest user profile by the private wireless communication network. A next step includes automatically connecting a non-browser-equipped guest user device to the private wireless communication network using the defined service set identification and pre-shared key of the guest user home wireless network, which have been preconfigured on that non-browser-equipped guest user device.

### BACKGROUND

Recently there has been an explosive growth of smart devices like smart phones, tablets, and the like that provide Internet connectivity. In using these new devices, users are increasingly consuming media from sources such as Netflix™ and iTunes™, among many others. Now with the growth of media streaming devices like Chromecast™ and Apple TV™ users can stream data at home using their home Internet and Wi-Fi hotspot devices. This is not a problem for home Wi-Fi hotspots since during setup such devices for streaming content are pre-configured for authentication with the known pre-shared key for the home Wi-Fi hotspot. However, guest users on other wireless networks (such as those presently being used in hotels, education facilities and hospitals) are now looking for a secure and seamless method to connect their media streaming devices to the wireless network at these premises and be able to view media content. However, most of the guest wireless networks are protected by captive portal, which is used at many open Wi-Fi hotspots. Captive portal directs a guest user on a network to a special browser web page that is typically used for authentication or payment purposes before allowing the guest user to use the Internet. However, devices like Chromecast™ and Apple TV™ do not have any browser functionality to allow them to connect or authenticate to the special browser web page presented by the wireless network.

Accordingly, there is a need to mitigate the above described guest user issues for devices that do not contain web browsers.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system, in accordance with the present invention.

FIG. 2 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention mitigates guest user media streaming issues for devices that do not contain web browsers, i.e. non-browser-enabled devices. In particular, the present invention provides authentication parameters to automatically provision the open network to the guest user, while also matching the guest user's requirements. This eliminates any requirement that the user authenticate multiple devices onto the open network. The present invention includes several variations for providing authentication parameters, including a mechanism for the guest users to be able to recreate their home wireless network environment, linking authentication parameters to guest profiles, and pushing authentication parameters to the open network via an application running an the guest's smart phone. Moreover, the present invention provides techniques for a guest's connection to the wireless network to remain active for the duration of the guest's stay at the facility. Further, each guest's connection to the wireless network is also put on a private virtual local area network so as to isolate their network from networks of other guests.

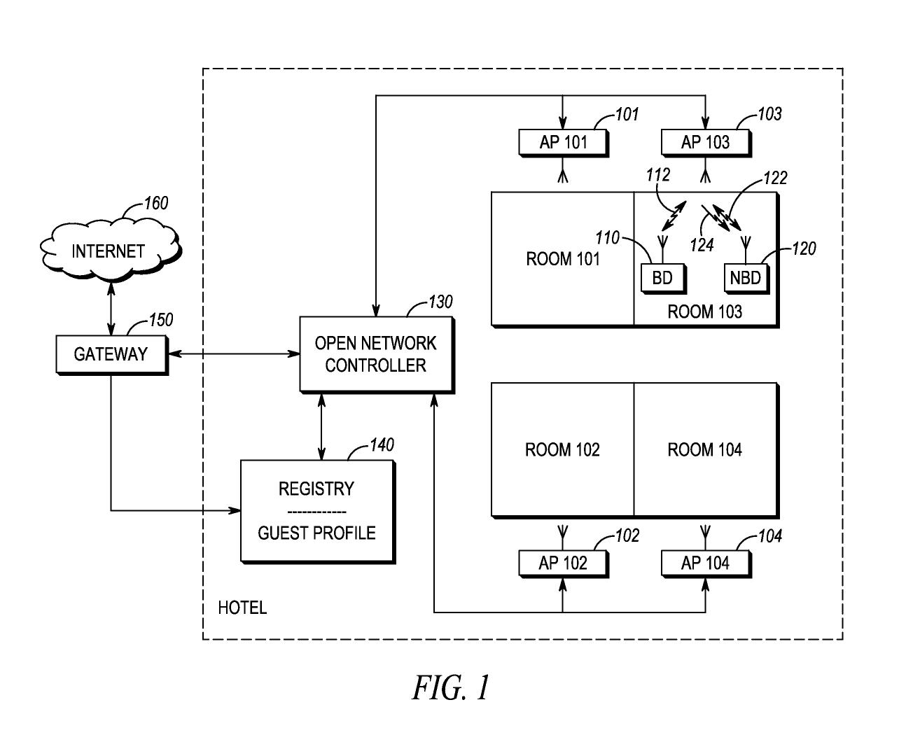

FIG. 1 shows an embodiment of the present invention as demonstrated in a hotel environment for example. However, it should be recognized that the present invention is equally applicable to other environments includes hospitals, healthcare institutions, educational institutions, businesses open to the public, other hospitality facilities and the like, where such a facility supports its own open network and allows guest users to temporarily access their wireless communication network, such as a wireless wide-area network (WWAN) or IEEE 802.xx-based wireless local area network (WLAN) communication system, modified to implement embodiments of the present invention. WWAN can be based on various wired or wireless technologies such as cellular networks, Ethernet, etc. WLAN can be based on various protocols including but not limited to IEEE 802.11. For example, the description that follows can apply to an access network that is IEEE 802.xx-based, employing wireless technologies such as RF, IrDA (infrared), Bluetooth, ZigBee (and other variants of the IEEE 802.15 protocol), IEEE 802.11 (any variation), IEEE 802.16 (WiMAX or any other variation), IEEE 802.20, Direct Sequence Spread Spectrum; Frequency Hopping Spread Spectrum; cellular/wireless/cordless telecommunication protocols not limited to GSM, CDMA, TDMA, GPRS, EDGE, LTE, UMTS, etc.; wireless home network communication protocols; paging network protocols; satellite data communication protocols; wireless hospital or health care facility network protocols such as those operating in the WMTS bands; GPRS; and proprietary wireless data communication protocols such as variants of Wireless USB, any of which can be modified to implement the embodiments of the present invention. However, it should be recognized that the present invention is also applicable to other wireless communication systems. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for such wireless telecommunications systems.

Referring to FIG. 1, there is shown a block diagram of a system adapted to support the inventive concepts of the preferred embodiments of the present invention. Those skilled in the art will recognize that FIG. 1 does not depict all of the equipment necessary for system to operate but only those system components and logical entities particularly relevant to the description of embodiments herein. Further, the equipment shown includes many communication components that are not shown for the sake of simplicity. In general, components such as processors, memories, wired and wireless transceivers, and the like, are well-known. For example, processing units are known to comprise basic components such as, but not limited to, microprocessors, microcontrollers, memory cache, application-specific integrated circuits, and/or logic circuitry. Such components are typically adapted to implement algorithms and/or protocols that have been expressed using high-level design languages or descriptions, expressed using computer instructions, expressed using messaging logic flow diagrams.

Thus, given an algorithm, a logic flow, a messaging/signaling flow, and/or a protocol specification, those skilled in the art are aware of the many design and development techniques available to implement processors that perform the given logic. Therefore, the devices shown represent a known apparatus that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the AP aspect of the present invention may be implemented in any of the devices listed above or distributed across such components. It is within the contemplation of the invention that the operating requirements of the present invention can be implemented in software, firmware or hardware, with the function being implemented in a software processor (or a digital signal processor) being merely a preferred option.

Various access points (AP) 101-104 are depicted in FIG. 1 distributed around premises, such as a hotel in this example. The APs are provided to serve the local communication needs of users in various locations within the premises. In this embodiment, the APs are positioned to service the local wireless communication needs of guests within at least each room of the hotel. Although this embodiment shows one AP for each room, it should be realized that one AP could serve more than one room or one room could have multiple APs serving it. Moreover, each AP can have multiple radios, each available to serve a different guest or communication need.

The APs are controlled by a local open network controller 130 that serves to provide an open wireless communication network operable to connect guest devices (e.g. browser-enabled device (BD) 110) to the internet 160 through a wireless or wired Ethernet connection to a service provider external (broadband) server or gateway 150. In this example, the hotel includes a guest registry or other type of system of memory that is used to hold guest information, including a guest user profile 140, in accordance with the present invention and as will be described in more detail below. For example, before arriving, a guest wishing to check-in to the hotel may access the hotel website hosted on the server provider gateway 150 via the internet 160. The guest can use the website to enter their particulars such as name, address, check-in/check-out times, payment information, and the like, into the guest registry, and then upon arrival at the hotel, the desk manager can simply pull up this information from the registry without having to re-enter it all over again.

It is envisioned that a guest will bring their own communication devices or terminals with them when they enter the premises. For example, a guest may bring a browser-enabled device (BD) 110, such as a smart phone or a tablet for example, and at least one non-browser-enabled device (NBD) 120, such as a Chromecast™ or Apple TV™ media streaming device, for example. Modern hotels are typically equipped with televisions that have High Definition Multimedia Interface (HDMI), Universal Serial Bus (USB) or other connections for such media streaming devices. The APs 101-104 uses a wireless interface for communication with multiple user devices, including browser-equipped and non-browser equipped devices 108, 110. The wireless interface corresponds to a forward link and a reverse link used in the implementation of various embodiments of the present invention. User equipment platforms are known to refer to a wide variety of consumer electronic platforms such as mobile stations, mobile units, mobile nodes, user equipment, subscriber equipment, subscriber stations, access terminals, remote terminals, terminal equipment, gaming devices, personal computers, and personal digital assistants, and the like.

Different types of user devices are known to comprise basic components such as, but not limited to, microprocessors, digital signal processors, microcontrollers, memory devices, application-specific integrated circuits, and/or logic circuitry. Such equipment is typically adapted to implement algorithms and/or protocols that have been expressed using high-level design languages or descriptions, expressed using computer instructions, expressed using messaging/signaling flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic.

Typically a user's communication devices have been pre-configured to operate on a user's home network. This type of pre-configuration makes connectivity of these devices easier since they are pre-programmed with the necessary parameters for each device to automatically authenticate and connect to the home network without further user intervention. However, when moving these devices to a remote network, each device typically needs to be re-configured with the remote network parameters in order to operate on that remote network. Such re-configuration usually entails a user first having a browser-enabled device that is capable of detecting any open network in the vicinity. Once selecting the network on the device, the user will be directed to manually enter the network access parameters, usually being a password. However, non-browser-enabled devices, such as a Chromecast™ or Apple TV™ media streaming device do not have a web browser and are therefore not able to access the open network directly. In this case the user may use an intermediate device, such as a computer or their smart phone, to re-program their non-browser-enabled devices with the open network's access parameters. The present invention eliminates this reprogramming by directing the open network to emulate the user's home network in accordance with the present invention, as will be detailed below.

In operation, the present invention provides a guest user profile that contains parameters for linking to a user's home network. For example, the guest user profile will contain at least a defined service set identification (SSID) and pre-shared key (PSK) of a home wireless network of the guest user, wherein the PSK may utilize any encryption protocol such as Wi-Fi Protected Access 2 (WPA2), for example.

The guest user profile can be established in the registry either before the guest arrives on the premises or at the time of arrival. For example, guests can provide their guest user profile along with their particulars such as name, address, check-in/check-out times, payment information, and the like, into the guest registry. Alternatively, if the guest is a regular user of the hotel, the guest can have their guest user profile permanently stored on the registry. In yet another alternative, the guest user profile can be provided at check-in, being entered manually by the guest at a kiosk or by the desk manager, or the guest user profile can be provided after check-in. For example, upon entering their room, such as room 103 in the example shown in FIG. 1, a user could use a browser on their smart phone BD 110 to connect to and access 112 the open network of the hotel, whereupon the guest could enter their name and room number for authentication. Upon authentication, a web page could be pushed to the smart phone from the gateway 150 where the web page can ask the guest if they want to create their own private network. If so, the guest could then enter their home SSID and PSK in guest user profile fields of the web page, which the gateway could then store in the hotel registry. In any of the above scenarios, the stored guest user profile 140 can be encrypted and non-retrievable by anyone other than the guest, such that no one else can obtain this information.

Once a guest user profile is established in the registry, the network controller can create a private wireless communication network with a unique identifier that is assigned to the guest. If a guest user profile was previously stored, this private network can be created automatically for the guest, at check-in for example. Alternatively, if a guest user profile was just entered, such as the above example where the guest enters their profile after entering their room, then the web page can ask the guest if they would like to create a private network, whereupon the guest can enter a unique identifier for that private network, or the network controller can select a unique identifier for that guest's private network, such as their room number for example.

Once the guest user profile and private network has been established (or pre-established), the gateway can interact with the network controller and registry software (such as a hotel Property Management System) in order to determine a location where the guest will be, such as the room number of the guest, and push an application programming interface (API) to the AP at that guest location (i.e. room) in order for that AP to configure itself with that guest's home SSID and PSK after the guest has checked-in. In the example shown, the AP 103 at room 103 will be configured with the guest's home SSID and PSK, for communicating on the private network. In practice, the private network will belong to a virtual local area network (VLAN) identified as VLAN 103 that is separate from other private networks, so as to isolate every user network from one another and prevent one user from discovering devices belonging to another user. Optionally, the present invention can be expanded to have the private network include multiple APs in an area so if the guest includes a family or a business that occupies multiple rooms, the private network could define a zone/area and all APs within that zone could be configured to serve the preprogrammed family or business clients.

At this point the selected AP 103 can begin, under the private network identifier, to broadcast a beacon 124 including the guest's defined SSID of their home wireless network to be detected by any of the guest's devices 110, 120.

Those non-browser-enabled devices 120, such as a Chromecast™ stick, that detects the beacon 124 from AP 103 can automatically authenticate with the AP 103 using its pre-configured SSID and PSK and begin communications 122 with the internet 160 via the AP 103, network controller 130, and provider gateway 150.

In some embodiments, the gateway or controller can determine a first time when the guest user will need access to the private network and a second time when the quest user will no longer need access to the private network, enable the creation of the private wireless communication network at the first time, and erase the private wireless communication network at the second time. In particular, the first time is a check-in time of the guest user within a hotel/hospital and the second time is a check-out time of the guest user within the hotel/hospital. The gateway or controller periodically retrieves a status of the guest user for determining changes to the first or second times.

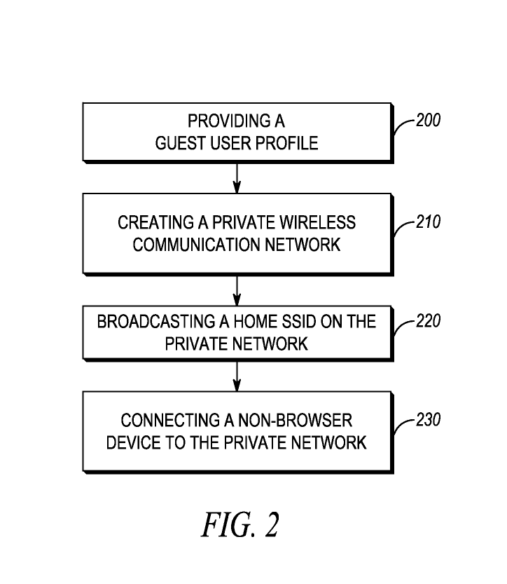

FIG. 2 illustrates a flowchart of a method to provide a private wireless communication network for guest users, in accordance with the present invention.

The method starts by providing 200 a guest user profile, including at least a defined service set identification and pre-shared key of a home wireless network of the guest user. In particular, this step includes creating and storing the guest user profile, and wherein creating includes creating a unique identifier for the private wireless communication network. The stored guest user profile can be encrypted and non-retrievable. The guest user profile can be pre-established of provided by a browser-equipped guest user device at check-in.

A next step includes creating 210 a private wireless communication network with a unique identifier, such as a room number of the guest. This can include establishing a location of the guest user. The private network can belong to a virtual local area network that is separate from other private networks. Optionally, creating includes determining a first (check-in) time when the guest user will need access to the private network and a second (check-out) time when the quest user will no longer need access to the private network, enable the creation of the private wireless communication network at the first time, and erase the private wireless communication network at the second time. This can include periodically retrieving a status of the guest user for determining changes to the first or second times.

A next step includes selectively broadcasting 220 the defined service set identification of the guest user home wireless network that is in the guest user profile by the private wireless communication network on only an access point serving a location of the guest; and

[symbol]

A next step includes automatically connecting 230 a non-browser-equipped guest user device to the private wireless communication network using the defined service set identification and pre-shared key of the guest user home wireless network, which have been preconfigured on that non-browser-equipped guest user device.

Advantageously, the present invention allows guest users to be able to securely connect all their devices including browser-enabled and non-browser-enables devices such as smart phones, tablets, Chromecast™, Apple TV™, and the like, securely in a private network without having to reconfigure these devices. The present invention can also automatically create and disable the private local network of the guest without any user intervention.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method to provide a private wireless communication network for guest users, the method comprising:
providing a guest user profile, including at least a defined service set identification and pre-shared key of a home wireless network of the guest user;
creating a private wireless communication network with a unique identifier for the guest user;
broadcasting the defined service set identification of the guest user home wireless network that is in the guest user profile under the private wireless communication network; and
automatically connecting a non-browser-equipped guest user device to the private wireless communication network using the defined service set identification and pre-shared key of the guest user home wireless network, which have been preconfigured on that non-browser-equipped guest user device.

2. The method of claim 1, wherein providing includes creating and storing the guest user profile, and wherein creating includes creating a unique identifier for the private wireless communication network.

3. The method of claim 1, wherein the unique identifier is a room number for the guest.

4. The method of claim 1, wherein providing includes the stored guest user profile being encrypted and non-retrievable.

5. The method of claim 1, wherein creating includes establishing a location of the guest user, and broadcasting includes selectively broadcasting the service set identification on only an access point serving that location.

6. The method of claim 1, wherein providing is performed by a browser-equipped guest user device entering the guest user profile.

7. The method of claim 1, wherein, in creating, the private network will belong to a virtual local area network that is separate from other private networks.

8. The method of claim 1, wherein creating includes:
determining a first time when the guest user will need access the private network and a second time when the quest user will no longer need access to the private network;
enabling creation of the private wireless communication network at the first time; and
erasing the private wireless communication network at the second time.

9. The method of claim 8, wherein the first time is a check-in time of the guest user and the second time is a check-out time of the guest user, and wherein determining includes periodically retrieving a status of the guest user for determining changes to the first or second times.

10. A system to provide a private wireless communication network for guest users, the system comprising:
a local open network controller operable to provide an open communication network;
a memory coupled to the local open network controller and operable to store a provided a guest user profile that includes at least a defined service set identification and pre-shared key of a home wireless network of the guest user;
a gateway coupled to the local open network controller and operable to create a private wireless communication network with a unique identifier for the guest user;
a plurality of access points communicatively connected with the gateway and the local open network controller, wherein only a selected access point at a location of the guest user is configured to broadcast the defined service set identification of the guest user home wireless network that is in the guest user profile under the private wireless communication network; and
a non-browser-enabled guest user device operable to automatically connect to the private wireless communication network using the defined service set identification and pre-shared key of the guest user home wireless network, which have been preconfigured on that non-browser-equipped guest user device.

11. The system of claim 10, wherein the unique identifier is a room number for the guest.

12. The system of claim 10, wherein the stored guest user profile is encrypted and non-retrievable.

13. The system of claim 10, further comprising a browser-enabled guest user device operable to provide the guest user profile to the memory.

14. The system of claim 10, wherein the private network will belong to a virtual local area network that is separate from other private networks.

15. The system of claim 10, wherein the gateway is further operable to determine a first time when the guest user will need access the private network and a second time when the quest user will no longer need access to the private network, enable creation of the private wireless communication network at the first time, and erase the private wireless communication network at the second time.
